(19) United States
(12) Patent Application Publication
(10) Pub. No.: US 2004/0180591 A1
(43) Pub. Date: Sep. 16, 2004

(54) Sealed edge food belt

(76) Inventor: Jules A. Haneburger, Newnan, GA (US)

Correspondence Address: Thomas L. Moses, Legal Department, M-495, PO Box 1926, Spartanburg, SC, 29304, US

(21) Appl. No.: 10/387,731

(22) Filed: Mar. 13, 2003

(51) Int. Cl. B32B 27/04; B32B 27/12; B32B 25/02; D04H 1/00

(52) U.S. Cl. 442/2; 442/37; 442/38; 442/208; 442/209; 442/213; 442/218; 442/220; 139/383 R; 139/384 R

(57) ABSTRACT

A belt reinforcing fabric for conveyor belts including sets of longitudinal warp yarns that are woven in leno weave fashion about lateral weft yarns that are made of monofilament. For each area on the fabric including sets of warp yarns, there is also an adjacent area that does not include warp yarns. Therefore, a space or gap is created between the areas occupied by the sets of warp yarns. When the belt is cut, it can be cut along the gap so that only the monofilament weft yarns are visible along the edges and not the warp yarns, which, if exposed at the cut edges, would tend to wick moisture into the belt. The present conveyor belt is particularly useful in conveying food items because of its tendency to reduce the opportunity to pick up and spread contaminating agents such as bacteria.

### BACKGROUND OF THE INVENTION

The present invention relates generally to conveyor belts, and more particularly to a novel and improved conveyor belt for carrying food articles.

In many processes, it is necessary to employ conveyor belts to transfer articles from one point to another. Particularly in food conveying systems, the material used in making the conveyor belts is important. Microorganisms are apt to grow on the belt surface due to adhered residues of food, and can contaminate the food articles, which may result in reduced shelf life of the food or spoilage. Additionally, the conveyor belt itself must be made of a “food-grade” quality material that resists agents such as fats, whether animal or vegetable. Accordingly, it is known in the food industries to use conveyor belts made of resin layers that contain antibacterial and antifungal agents.

Alternatively, it is known to make conveyor belts of polyurethane because of their ability to resist contamination when used to transfer food items. Polyurethane belts can be cleaned and sanitized with relative ease. Further, these belts meet various government standards that apply to food conveyor belt systems. However, belts made of polyurethane tend to stretch over time and have an overall short life cycle for their intended use. This practical limitation results in increased cost not only from the cost of the replacement belt, but also from the down time spent replacing the belts. To address this problem of stretch, the polyurethane belts can be reinforced with fabrics or textiles. As used herein, the term “textiles” is used to refer to fabric reinforcing material. By embedding fabrics or textiles in the polyurethane belt material, the degree of stretch can be limited.

Although textile-reinforced polyurethane belts avoid the problem of stretching, another problem typically arises from such a construction. Because textiles are not “solid” but rather have holes and gaps between fibers which provide numerous sites that can bind liquids, the exposed textiles at the edges of the textile-reinforced belts can become a source of contamination for food items traveling on the conveyor belt. Moisture from the food will be wicked into the belt at areas where the textile is exposed. The term “wicking” refers to the dispersing or spreading of moisture or liquid by capillary action through a given area, vertically or horizontally. When wicking occurs in these belts, agents such as microbes and blood can also migrate into the textile. Additionally, the moisture can cause the bonding between the textile and the polyurethane to loosen.

Accordingly, there remains a need for an improved conveyor belt for carrying food that does not have the limitations and shortcomings of the above described devices.

### SUMMARY OF THE INVENTION

According to its major aspects and briefly recited, the present invention is a new and improved belt reinforcing fabric including longitudinal warp yarns that are woven in a leno weave about lateral weft yarns that are monofilament. For each area on the fabric including warp yarns, there is also an adjacent area that does not include warp yarns. Therefore, gaps are left between the sets of warp yarns in the manufacture of the reinforcing textile. When the resulting fabric-reinforced belt is cut, the cut can be made at the gap so that only the monofilament weft yarns are exposed and not also the warp yarns.

A particular feature of the present invention is the use of monofilament yarns in the weft direction of the belt reinforcing fabric. Because monofilament yarns are solid, rather than composed of individual fibers twisted together, they can help to prevent wicking into the sides of the belt. Further, as the conveyor belts are slit longitudinally, the placement of the monofilament in the weft direction allows the edges of the conveyor belt to be substantially sealed from the problem of migration of contaminating agents into the fabric.

Another feature of the present invention is the use of warp yarns that are grouped in such a way as to define gaps between the areas that include warp yarn. These gaps provide a suitably wide place in a conveyor belt into which the fabric is embedded to be slit longitudinally so that only the weft monofilament yarns of the fabric are exposed. Because monofilament yarns do not experience wicking, the edges formed from slitting the belt become sealed from contamination brought on by wicking. In typical textile reinforced conveyor belts that are longitudinally slit, the exposed textile becomes frayed, significantly contributing to the wicking of contaminants into the fabric and belt. Therefore, providing gaps adjacent to the warp yarn area is particularly advantageous in the food industry, as materials such as blood and microorganisms are prone to wick into the edges of the reinforced conveyor belts. Further, by decreasing the number of warp yarns in relation to weft yarns in the fabric construction, the overall cost associated with the conveyor belt is decreased.

Other features and advantages of the present invention will be apparent to those skilled in the art from a careful reading of the Detailed Description of the Preferred Embodiment presented below and accompanied by the drawings.

### BRIEF DESCRIPTION OF THE DRAWINGS

FIG. 1 is a plan view of a belt reinforcing fabric according to a preferred embodiment of the present invention; and

FIG. 2 is a perspective view of a section of a conveyor belt having reinforcing fabric according to a preferred embodiment of the present invention.

### DETAILED DESCRIPTION OF THE PREFERRED EMBODIMENTS

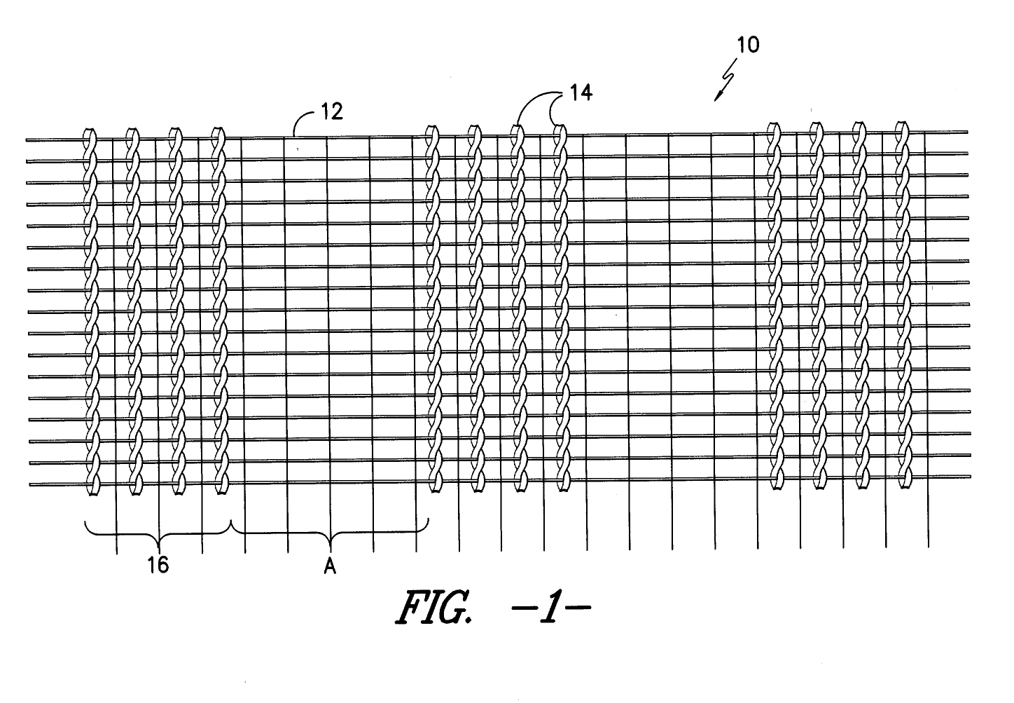

In FIG. 1, there is shown a belt reinforcing fabric 10 of the present invention. Fabric 10 generally includes lateral weft yarns 12 and longitudinal warp yarns 14 that are woven in leno weave fashion about weft yarns 12. Leno weaving or “lenoing” is a weaving method used to cross and uncross two or more warp yarns 14 in an organized fashion about the weft yarns 12 thus locking the warp yarns 14 to a position of the weft yarns 12. A basic leno weave requires pairs of warp yarns 14 where each yarn in the pair twists with the other. However, the use of other leno weaves is contemplated by the present invention. The warp yarns 14 can be twisted about each weft yarn 12 or about alternating weft yarns 12 or about a plurality of weft yarns 12. More than one pair of warp yarns 14 may be adjacent to each other with either the same twist pattern or different twist patterns. The paired yarns may be made of a different fiber and/or have a different twist. Accordingly, the leno weave of the present invention includes but is not confined to basic leno weave as shown in FIG. 1 where pairs of warp yarns 14 are twisted, but also other variations of a leno weave may also be used where more than two yarns are twisted together such as one yarn being lenoed with two or two with two. It is further contemplated by the present invention to include other types of weaves than the leno weave, including plain weave, twill weave or oxford weave. However, these other types of weaves are preferably used in combination with leno weave.

More specifically, the preferred embodiment of fabric 10 includes 7 warp yarns 14 of 1000 denier 2 ply polyester warp (i.e., two ends of 1000 denier yarn that has been twisted or plied together) per inch and weft yarns 12 of 8 mil (i.e., 8 thousandths of an inch in diameter) polyester monofilament woven at approximately 10 picks or weft yarn 12 ends per inch. Further, the warp yarns 14 of fabric 10 are alternately “S” and “Z” twisted so as to enhance the tracking of the resulting belt on the conveyor system. It is contemplated that the denier of the warp yarn 14 and/or weft yarn 12, as well as the number of warp yarns 14 and/or weft yarns 12 per inch can be increased or decreased, as preferred in meeting the strength requirement of the finished belt. Preferably, the number of warp yarns 14 per inch ranges between 6 to 14 with a denier ranging between 200 to 4000 per end. The preferred number of weft yarns 12 per inch ranges between 4 to 12 with a diameter ranging between 6 to 14 mils.

As shown, warp yarns 14 of fabric 10 are grouped into sets 16 of warp yarns 14. Each set 16 is spaced apart from an adjacent set 16 so that a gap A is provided between sets 16. The area and spacing of gap A can be changed to meet specific requirements. Depending on the size of the resulting belt, as well as the process for making the resulting belt, the spacing and area of gap A can be increased or decreased. For example, if the process used to make the resulting belt includes a blade having a certain width for slitting the belt, then gap A must have a width at least greater than that of the blade so that no warp yarns 14 are exposed by the slitting. Preferably, gap A has a width of ⅜″ to 1″ and can be included every 1 to 3 inches along the width of fabric 10. Most preferably, the linear distance in the weft direction of the fabric 10 that is occupied by the set 16 is approximately equal to the linear distance of the gap A. Although the warp yarns 14 illustrated in FIG. 1 are each leno weaved, the use of other types of weaves as previously described is contemplated by the present invention. In the case that a combination of weaves is employed, the outer warp yarns 14 of each set 16 preferably remain leno weaved, and the inner warp yarns 14 of the sets 16 may include alternative weaves such as plain weave, twill weave, or oxford weave.

As previously discussed, a particular feature of the present invention is the use of monofilament yarns in the weft direction of the belt reinforcing fabric 10. This feature in combination with the use of warp yarns 14 that are grouped in sets to create gaps A adjacent to the areas including warp yarns 14 enable the fabric 10 to be slit longitudinally and to form edges that are sealed from contamination caused by wicking into the yarn. As used herein, the term “monofilament” refers to any single filament of a manufactured fiber. Instead of a group of filaments being extruded through a spinneret to form a yarn, such as the warp yarns 14 of the present invention, monofilaments generally are spun individually. Further, monofilament yarns are made of a solid plastic, such as a polyester or nylon polymer. Therefore, contaminants such as blood, moisture, and microorganisms do not wick onto the monofilament weft yarns 12 and do not spread into the reinforcement fabric 10.

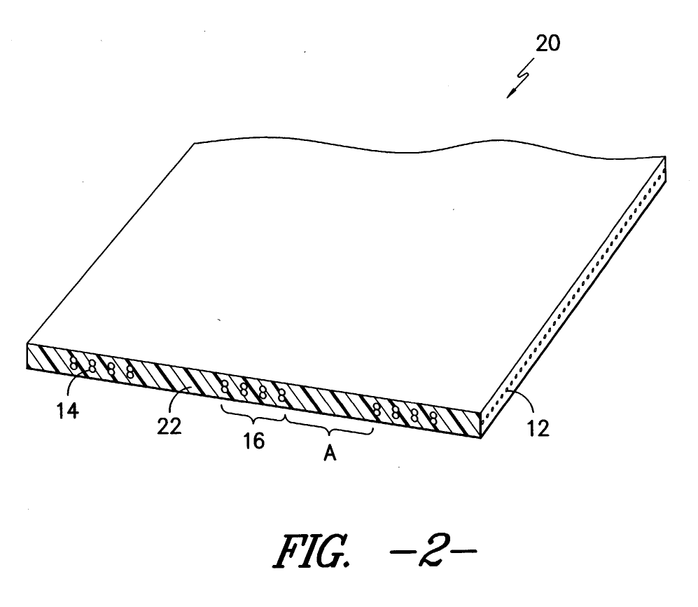

As illustrated in FIG. 2, the belt reinforcing fabric 10 of the present invention can be incorporated into a material to form a fabric-reinforced conveyor belt 20. Conveyor belt 20 preferably includes a solid layer of material 22 such as polyurethane or PVC (polyvinyl chloride). During the process for making the conveyor belt 20, the belt reinforcing fabric 10 is integrated within the layer of material 22, as shown. Thereafter, the conveyor belt 20 is slit longitudinally in the areas including spaces A not including warp yarns 14 so that edges 24 are formed exposing only the lateral weft monofilament yarns 12. The construction of conveyor belt 20 makes the belt particularly well suited for carrying food articles. Materials such as polyurethane have the ability to handle food they can be cleaned and sanitized with relative ease. Further, belts made of these types of materials meet various government standards that apply to food conveyor belt systems. With the incorporation of a reinforcement fabric, the main disadvantage of polyurethane belts, which is stretching, is minimized. Finally, the use of the reinforcement fabric 10 as described in the present invention is particularly advantageous, as the edges 24 of the conveyor belt 20 expose only monofilament weft yarns 12, which do not experience wicking of contaminants. Because the problem of contamination infesting the interior of the belt is virtually eliminated, the overall life of the conveyor can be increased.

Those skilled in the art of conveyor belts and belt reinforcing fabrics will recognize that many substitutions and modifications can be made in the foregoing preferred embodiments without departing from the spirit and scope of the present invention.

What is claimed is:

1. A belt reinforcing fabric, comprising:
a plurality of weft yarns; and
a plurality of warp yarns that are woven about said weft yarns, wherein said warp yarns are grouped into spaced apart sets of warp yarns thereby defining a gap therebetween.

2. The fabric as recited in claim 1, wherein said warp yarns are woven about said weft yarns in a leno weave fashion.

3. The fabric as recited in claim 1, wherein said warp yarns are woven in a combination of weaving patterns, and wherein the outside warp yarns of said sets of warp yarns are leno woven.

4. The fabric as recited in claim 1, wherein said warp yarns are 2 ply yarns that are between 200 and 4000 denier.

5. The fabric as recited in claim 1, wherein said warp yarns are polyester yarns.

6. The fabric as recited in claim 1, wherein said weft yarns have a diameter ranging from 6 to 14 mils.

7. The fabric as recited in claim 1, wherein said weft yarns are monofilament yarns.

8. The fabric as recited in claim 7, wherein said monofilament yarns are made of a solid plastic.

9. The fabric as recited in claim 8, wherein said plastic is selected from a group consisting of polyester and nylon.

10. The fabric as recited in claim 1, wherein said weft yarns are woven at a range between 4 and 12 picks per inch.

11. The fabric as recited in claim 1, wherein said warp yarns are woven at a range between 6 and 14 warp yarns per inch.

12. The fabric as recited in claim 1, wherein each said set of warp yarns occupies a linear distance in a weft direction and wherein said gap between said sets is dimensioned to be approximately equal to said linear distance occupied by said set of warp yarns.

13. The fabric as recited in claim 1, wherein said gap has a width ranging from ⅜ to 1 inch.

14. The fabric as recited in claim 1, wherein said fabric as a width, and wherein said gap is included every 1 to 3 inches along said width.

15. A conveyor belt, comprising:
a layer of material; and
a fabric integrated into said material, and wherein said fabric includes a plurality of weft yarns and a plurality of warp yarns that are woven about said weft yarns, wherein said warp yarns are grouped into sets of warp yarns, and wherein said sets are spaced apart to define gaps therebetween.

16. The belt as recited in claim 15, wherein said material is selected from a group consisting of polyurethane and polyvinyl chloride.

17. The belt as recited in claim 15, wherein said warp yarns are woven about said weft yarns in a leno weave fashion.

18. The fabric as recited in claim 15, wherein said warp yarns are woven in a combination of weaving patterns, and wherein the outside warp yarns of said sets of warp yarns are leno woven.

19. The belt as recited in claim 15, wherein said warp yarns are 2 ply yarns that are between 200 and 4000 denier.

20. The fabric as recited in claim 15, wherein said warp yarns are woven at a range between 6 and 14 warp yarns per inch.

21. The belt as recited in claim 15, wherein said warp yarns are polyester yarns.

22. The belt as recited in claim 15, wherein said weft yarns have a diameter ranging from 6 to 14 mils.

23. The belt as recited in claim 15, wherein said weft yarns are monofilament yarns.

24. The belt as recited in claim 15, wherein said weft yarns are woven at a range between 4 and 12 picks per inch.

25. The belt as recited in claim 15, wherein each said set of warp yarns occupies a linear distance in a weft direction and wherein said gap between said sets is dimensioned to be approximately equal to said linear distance occupied by said set of warp yarns.

26. The fabric as recited in claim 15, wherein said gap has a width ranging from ⅜ to 1 inch.

27. The fabric as recited in claim 15, wherein said fabric has a width, and wherein said gap is included every 1 to 3 inches along said width.
